(19) United States
(12) Patent Application Publication
(10) Pub. No.: US 2013/0085431 A1
(43) Pub. Date: Apr. 4, 2013

(54) COMPRESSION BLADDER HAVING PRE-STRAINED BLADDER MATERIAL

(71) Applicant: Arnaz S. Malhi, Watertown, MA (US)

(72) Inventor: Arnaz S. Malhi, Watertown, MA (US)

(73) Assignee: TYCO HEALTHCARE GROUP LP, Mansfield, MA (US)

(21) Appl. No.: 13/248,362

(22) Filed: Sep. 29, 2011

(51) Int. Cl. A61H 7/00

(52) U.S. Cl. 601/150

(57) ABSTRACT

A compression apparatus for providing a therapeutic compression pressure to a wearer's body. The apparatus includes an inflatable bladder formed from bladder material, a controller, and a pump operatively connectable to the bladder for pressurizing the bladder. The controller has a pre-therapeutic compression function for instructing the pump to pressurize the bladder to an elevated pressure above the therapeutic compression pressure and to maintain the elevated pressure for a period of time before depressurizing the bladder.

### FIELD OF THE INVENTION

The present invention generally relates to compression sleeves, and more particularly to compression sleeve bladders having pre-strained bladder material.

### BACKGROUND OF THE INVENTION

Pneumatic compression sleeves can be used to apply intermittent compression therapy to a patient's limbs, such as a wearer's leg to prevent deep vein thrombosis (DVT). However, sleeves of this type can be used in other applications, including those in which a constant compression is applied during treatment. Bladders for pneumatic compression sleeves are usually made by welding together two sheets of plastic film. These bladders inflate when gas is introduced by a pump connected to the compression sleeve. The inflation of the bladders imparts a compressive force on a leg of a patient wearing the sleeve. A controller operatively connected to the sleeve controls the amount of pressure in the bladder and the rate at which the pump delivers pressure to the bladder.

In the interest of patient comfort and portability, there is a need to make these controllers and pumps as small as possible. The result, however, is a decrease in the flow capacity of the pump due to its small size. This can impede the pump's ability to meet the inflation required to provide adequate therapeutic compression pressure to the patient's limb. Thus, a need exists to improve the compressive capability of compression sleeves having relatively small controllers and pumps.

### SUMMARY OF THE INVENTION

In one aspect, a compression apparatus for providing a therapeutic compression pressure to a wearer's body when the apparatus is applied to the wearer's body generally comprises an inflatable bladder formed from bladder material defining an internal cavity. The apparatus also includes a pump operatively connectable to the bladder for selectively pressurizing the bladder by introducing gas into the internal cavity of the bladder. In addition, the apparatus has a controller operatively connected to the pump for controlling bladder pressurization when the pump is operatively connected to the bladder. The controller has a pre-therapeutic compression function for instructing the pump to introduce gas into the internal cavity of the bladder to pressurize the bladder to an elevated pressure above the therapeutic compression pressure and to maintain the elevated pressure for a period of time before depressurizing the bladder. The function increases a tensile modulus of elasticity of the bladder material defining the interior cavity of the bladder and reduces an amount of gas required to pressurize the bladder to the therapeutic compression pressure when the apparatus is applied to the wearer's body.

In another aspect, a method of operating a controller for forming a pre-strained inflatable bladder used in a compression apparatus for applying a therapeutic compression pressure to a wearer's body when the inflatable bladder is applied to the wearer's body. The inflatable bladder is formed of bladder material defining an internal cavity. The method generally comprises controlling with an electronic controller the compression apparatus to supply gas until an elevated back pressure is detected that exceeds back pressure for use of the controller with the inflatable bladder for applying compression therapy to the wearer's body and sufficiently great to increase a tensile modulus of elasticity of the bladder material. The elevated back pressure is maintained by operation of the controller for a period of time selected to increase the tensile modulus of elasticity of the bladder material thereby reducing an amount of gas required to pressurize the bladder to the therapeutic compression pressure when the apparatus is applied to the wearer's body.

In yet another aspect of the present invention, a compression apparatus for applying therapeutic compression to a wearer's body generally comprises first and second sheets of bladder material that are secured together to define a bladder. The bladder has a port therein for receiving gas into the bladder to inflate the bladder for use in applying compression to the wearer's body. At least one of the first and second sheets of bladder material is strained so that a tensile modulus of elasticity of said at least one of the first and second sheets of bladder material is increased.

Other objects and features will be in part apparent and in part pointed out hereinafter.

### BRIEF DESCRIPTION OF THE DRAWINGS

FIG. 1 is a schematic of a compression apparatus of the present invention;

FIG. 2 is a front elevation of a compression sleeve of the compression apparatus with an outer cover and bladder layer of the sleeve partially removed to show underlying layers and components;

FIG. 3 is a flow chart of a pre-therapeutic compression function of the compression apparatus; and

FIG. 4 is a graphical illustration of the pre-therapeutic compression function of the compression apparatus.

Corresponding reference characters indicate corresponding parts throughout the drawings.

### DESCRIPTION OF THE PREFERRED EMBODIMENTS

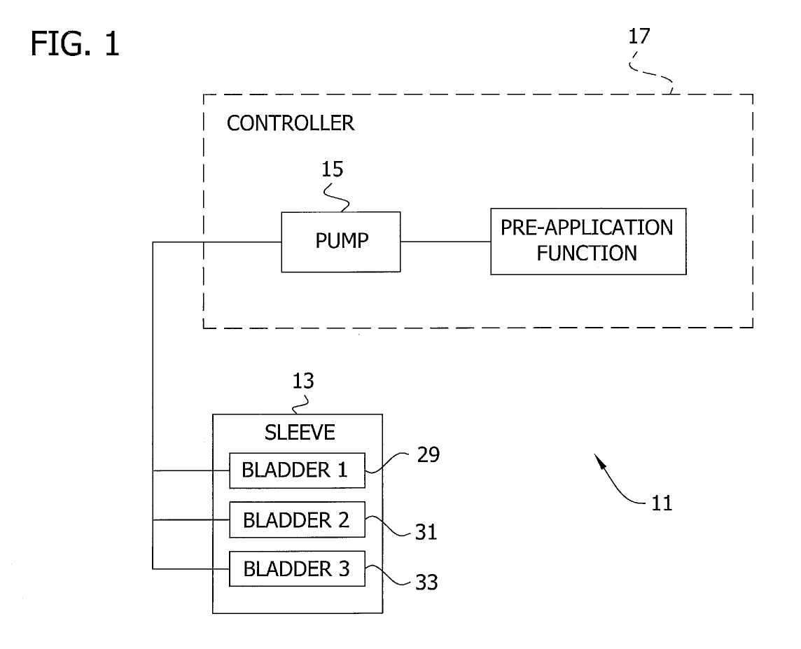

Referring to FIG. 1, a compression apparatus of the present invention is generally indicated at 11. The compression apparatus is configured to apply repeated, sequential compression therapy to a limb of a wearer. The compression apparatus 11 comprises a sleeve 13 sized and shaped to be wrapped around a leg of the wearer. A pump 15 is operatively connected to the sleeve 13 for selectively pressurizing the sleeve by introducing gas into the sleeve. A controller 17 is operatively connected to the pump 15 for controlling the pressurization of the sleeve 13.

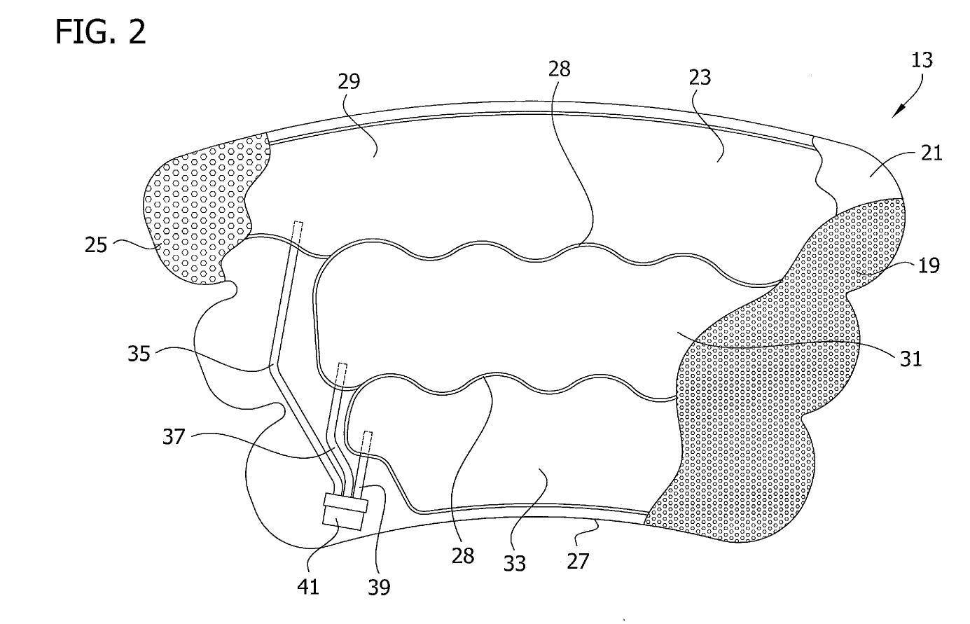

Referring to FIG. 2, the sleeve 13 is a knee-length sleeve. It will be understood that the compression sleeve 13 may have other configurations, such as a thigh-length sleeve. Other types of compression devices for wrapping around other limbs of the wearer's body are envisioned as being within the scope of this invention as well. These other devices include devices that do not apply compression repeatedly and/or sequentially.

In the illustrated embodiment, the compression sleeve 13 has four layers secured together. The compression sleeve 13 has an inner layer, generally indicated at 19, on which an inner intermediate layer (broadly, an inner bladder layer), generally indicated at 21, is overlaid. An outer intermediate layer (broadly, an outer bladder layer), generally indicated at 23, overlies the inner intermediate layer 21 and is secured thereto. An outer layer or cover generally indicated at 25 overlies and is secured to the outer intermediate layer 23. The layers 19-25 may be secured together in any suitable manner as by radiofrequency welding, adhesive, or other chemical and/or mechanical process. In the illustrated embodiment, the layers 19-25 are secured about a periphery 27 of the sleeve 11. Further, the inner and outer intermediate layers 21, 23 are joined together to produce generally fluid-tight internal cavities. As the methods for joining these layers is well known by those skilled in the art, they will not be described in further detail.

In use, the inner layer 19 is disposed closest to the limb of the wearer and is in contact with the limb of the wearer, and the outer cover 25 is farthest from the limb of the wearer. The inner and outer layers 19, 25 may be made of a polyester material. The inner layer 19 can be absorbent and have a soft texture to provide a comfortable interface with the wearer's body. The scope of the present invention is not limited to four layers. Also, it is understood that the configuration of the layers 19-25 of the sleeve 13 can be different than that disclosed in the illustrated embodiment.

The inner and outer intermediate layers 21, 23 respectively, each include at least one sheet of elastic material (broadly, “bladder material”). For example, in some embodiments the sheets 21, 23 are made of a pliable PVC material having a thickness of about 0.005 inches. The outer intermediate layer 23 can be sealingly secured to the inner intermediate layer 21 along bladder seam lines 28 to define a proximal bladder 29, an intermediate bladder 31 and a distal bladder 33, respectively, that are spaced longitudinally along the sleeve 13. It is understood that the intermediate layers 21, 23 may be secured together at other locations, such as around their peripheries. Also, the number of bladders may vary from three without departing from the scope of the present invention. In some embodiments, a single intermediate folded sheet may replace the inner and outer intermediate layers 21, 23 to form the bladder(s).

As used herein, the terms “proximal”, “distal”, and “intermediate” represent relative locations of components, parts and the like of the compression sleeve when the sleeve is secured to the wearer's limb. As such, a “proximal” component or the like is disposed most adjacent to a point of attachment of the wearer's limb to the wearer's torso, a “distal” component is disposed most distant from the point of attachment, and an “intermediate” component is disposed generally between the proximal and distal components.

Each bladder 29, 31, 33 has an internal cavity that is selectively filled with gas (e.g., air) from a source of compressed gas such as pump 15 via a dedicated proximal bladder tube 35, a dedicated intermediate bladder tube 37, or a dedicated distal bladder tube 39, respectively, for inflating the bladders. However, the tube lines need not be dedicated to a single bladder to practice the invention. In the illustrated embodiment, each tube 35, 37, 39 is positioned at least partially between the outer intermediate layer 23 and the outer cover 25, and secured between the inner and outer intermediate layers 21, 23 to the respective bladders 29, 31, 33 by respective bladder seam lines 28. Other ways of securing the tubes 35-39 to the bladders 29-33 are envisioned as being within the scope of the invention. Ends of the tubes 35-39 opposite the bladders 24-33 are joined using a connector 41 adapted to fluidly connect the tubes to the pump 15. The pump 15 is operatively connected to the controller 17 for instructing the pump to sequentially pressurize the bladders 29-33 as is generally known in the art. An exemplary pump 15 is described in U.S. Pat. No. 5,876,359 to Bock, the disclosure of which is incorporated herein by reference.

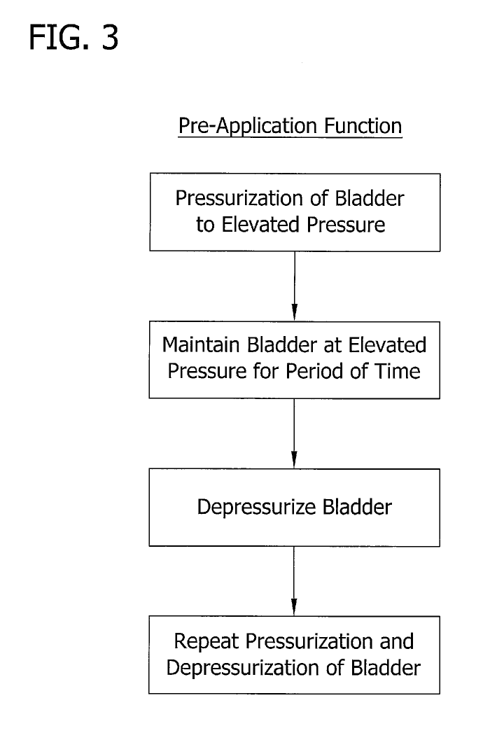

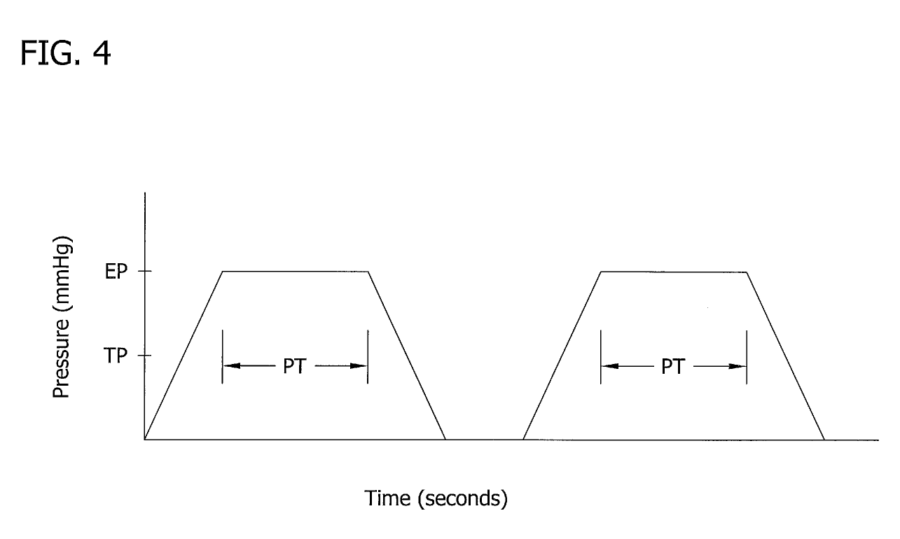

The controller 17 is programmed to control pressurization of the bladders 29-33 of the sleeve 13 during therapeutic compression when the sleeve is applied to the wearer's body. As used herein, “therapeutic compression” means compression that is used to prevent the onset of certain conditions (e.g., blood clotting) as well as treatment of an existing condition (e.g., edema). The controller 17 also includes a pre-therapeutic compression function that is used before therapeutic compression and/or before the sleeve is applied to the wearer. Referring to FIGS. 1, 3, and 4, the controller 17 has a programmed pre-therapeutic compression function wherein the controller instructs the pump 15 to pressurize the bladders 29-33 to an elevated pressure EP above a therapeutic compression pressure TP used for compression therapy. The controller measures the back pressure. The controller 17 is programmed to initiate the pre-therapeutic compression function prior to the application of the sleeve 13 to the wearer's body and prior to the initiation of the therapeutic compression cycle. The controller 17 instructs the pump 15 to deliver gas to the bladders 29-33 at an elevated pressure EP of at least about 60 mmHg. In some embodiments, the elevated pressure may be in a range from about 60 mmHg to about 120 mmHg. This range is selected because it is typically higher than the range of pressure levels used during a therapeutic compression cycle but does not usually cause discomfort to the wearer. Typically, the pressure used during therapeutic compression ranges between about 15 mmHg and about 60 mmHg. During compression to elevated pressure EP, the rate of pressurization may be intentionally slow to minimize discomfort to the wearer.

After pressurizing the bladders 29-33 to the elevated pressure EP, the controller 17 maintains the elevated pressure for a selected period of time PT before depressurizing the bladders. In one embodiment, the controller 17 maintains the elevated pressure EP for at least about 120 seconds before depressurizing the bladders 29-33. In a preferred embodiment, the controller 17 maintains the elevated pressure EP for about 60 seconds before depressurizing the bladders 29-33. After the bladders 29-33 have been depressurized, they can be re-pressurized to the elevated pressure EP and held at the elevated pressure for a selected period of time PT before again being depressurized. This cycle can be repeated any number of times.

The process of pressurizing the bladders 29-33 to an elevated pressure EP and holding the bladders at the elevated pressure strains the bladder material. Since the process is preferably performed before the sleeve 13 is used for therapeutic compression, it is considered a “pre-straining” process. The process could, for example, be carried out during leak testing of the bladders 29-33. Because the bladders 29-33 are formed from a polymer material, the pre-straining process increases a tensile modulus (sometimes referred to as “Young's modulus”) of the bladder material which reduces the volume of gas needed to pressurize the bladders to the therapeutic compression pressure once the sleeve 13 is applied to the wearer's body. Without being limited to any particular theory of operation, it is believed that by increasing the tensile modulus of elasticity, the bladder will tend to hold its shape and retain more gas when deflated. Therefore, less air is required on subsequent inflation to fill the bladder. The reduction in volume of required gas allows smaller pumps having lower flow capacities to be used to pressurize the bladders 29-33 to the desired therapeutic compression levels during compression therapy. Because smaller pumps add comfort and portability to the compression apparatus, being able to use these smaller pumps is beneficial to the wearer of the sleeve 13.

When introducing elements of the present invention or the preferred embodiments(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the invention are achieved and other advantageous results attained.

As various changes could be made in the above constructions without departing from the scope of the invention, it is intended that all matter contained in the above description and shown in the accompanying drawings shall be interpreted as illustrative and not in a limiting sense.

What is claimed is:

1. A compression apparatus for inflating an inflatable bladder formed from bladder material and having an internal cavity to provide a therapeutic compression pressure to a wearer's body when the inflatable bladder is applied to the wearer's body, the apparatus comprising:
a pump operatively connectable to the bladder for selectively pressurizing the bladder by introducing gas into the internal cavity of the bladder; and
a controller operatively connected to the pump for controlling bladder pressurization when the pump is operatively connected to the bladder, the controller having a pre-therapeutic compression function for instructing the pump to introduce gas into the internal cavity of the bladder to pressurize the bladder to an elevated pressure above the therapeutic compression pressure and to maintain the elevated pressure for a period of time before depressurizing the bladder thereby increasing a tensile modulus of elasticity of the bladder material defining the interior cavity of the bladder and thereby reducing an amount of gas required to pressurize the bladder to the therapeutic compression pressure when the apparatus is applied to the wearer's body.

2. A compression apparatus as set forth in claim 1 wherein the controller is programmed to pressurize the bladder to the elevated pressure prior to controlling the pump for applying therapeutic compression.

3. A compression apparatus as set forth in claim 1 wherein during operation of the pre-therapeutic compression function the controller instructs the pump to re-pressurize the bladder to the elevated pressure after depressurizing the bladder.

4. A compression apparatus as set forth in claim 1 wherein the elevated pressure is at least about 60 mmHg.

5. A compression apparatus as set forth in claim 4 wherein the elevated pressure is about 120 mmHg.

6. A method of operating a controller for forming a pre-strained inflatable bladder used in a compression apparatus for applying a therapeutic compression pressure to a wearer's body when the inflatable bladder is applied to the wearer's body, the inflatable bladder being formed of bladder material defining an internal cavity, the method comprising
controlling with an electronic controller the compression apparatus to supply gas until an elevated back pressure is detected that exceeds back pressure for use of the controller with the inflatable bladder for applying compression therapy to the wearer's body and sufficiently great to increase a tensile modulus of elasticity of the bladder material;
maintaining by operation of the controller the elevated back pressure for a period of time selected to increase the tensile modulus of elasticity of the bladder material thereby reducing an amount of gas required to pressurize the bladder to the therapeutic compression pressure when the apparatus is applied to the wearer's body.

7. A method of claim 6 further wherein controlling the compression apparatus with an electronic controller includes maintaining the elevated back pressure prior to controlling the compression apparatus to apply therapeutic compression.

8. A method of claim 6 further comprising controlling by operation of the controller the compression apparatus to relieve the elevated back pressure and then to supply gas again until the elevated back pressure is detected.

9. A method of claim 6 wherein the elevated back pressure is at least about 60 mmHg.

10. A method of claim 9 wherein the elevated back pressure is about 120 mmHg.

11. A method of claim 9 wherein the elevated back pressure is maintained for a period of at least about 60 seconds before relieving the elevated back pressure.

12. A method of claim 11 wherein the elevated back pressure is maintained for a period of about 120 seconds before relieving the elevated back pressure.

13. A compression apparatus for applying therapeutic compression to a wearer's body, the compression apparatus comprising first and second sheets of bladder material that are secured together to define a bladder, the bladder having a port therein for receiving gas into the bladder to inflate the bladder for use in applying compression to the wearer's body, at least one of the first and second sheets of bladder material being strained so that a tensile modulus of elasticity of said at least one of the first and second sheets of bladder material is increased.

14. A compression apparatus as set forth in claim 13 wherein both the first and second sheets of bladder material are strained to increase the tensile modulus of elasticity.

15. A compression apparatus as set forth in claim 14 wherein the first and second sheets of bladder material are formed separately from each other prior to being secured together.
